(19) United States
(12) Patent Application Publication
(10) Pub. No.: US 2023/0019325 A1
(43) Pub. Date: Jan. 19, 2023

(54) BATTERY CONTAINMENT CONSTRUCT

(71) Applicant: Teijin Automotive Technologies, Inc., Auburn Hills, MI (US)

(72) Inventors: Eric J. Haiss, Auburn Hills, MI (US); Masatomo Teshima, Auburn Hills, MI (US); Hugh Foran, Auburn Hills, MI (US)

(73) Assignee: Teijin Automotive Technologies, Inc., Auburn Hills, MI (US)

(21) Appl. No.: 17/791,550

(22) PCT Filed: Jan. 8, 2021
(86) PCT No.: PCT/US2021/012618

§ 371 Date: Jul. 8, 2022

Related U.S. Application Data
(60) Provisional application No. 62/958,376, filed on Jan. 8, 2020.

(51) Int. Cl. H01M 50/229; H01M 50/24; H01M 50/262

(52) U.S. Cl. CPC H01M 50/229; H01M 50/24; H01M 50/262

(57) ABSTRACT

A high strength, light weight battery containment construct for containing and protecting energy cells and providing impact, fire, and fluid penetration resistance includes a first housing portion, a second housing portion, and a joiner clip configured to hold the first housing portion and second housing portion together. The first housing portion has a first body and a first flange extending from the first body. The second housing portion has a second body and a second flange extending from the second body. The second flange is configured to engage the first flange such that the first body of the first housing portion and the second body of the second housing portion define a cavity therebetween. The joiner clip is configured with a C-shaped cross section to engage the first flange and the second flange to join the first housing portion to the second housing portion.

### CROSS-REFERENCE TO RELATED APPLICATION

This application claims priority of U.S. Provisional Patent Application Ser. No. 62/958,376 filed Jan. 8, 2020, which is incorporated herein by reference.

### FIELD OF THE INVENTION

The present invention in general relates to a high strength, light weight containment construct and in particular to a high strength, light weight containment construct for containing for example, a fuel cell or battery, to provide impact resistance, fire resistance, and fluid penetration prevention.

### BACKGROUND OF THE INVENTION

Weight savings in the automotive, transportation, aerospace, and logistics-based industries has been a major focus in order to make more fuel-efficient vehicles both for ground and air transport. In order to achieve these weight savings, light weight composite materials have been introduced to take the place of metal structural and surface body components and panels. Composite materials are materials made from two or more constituent materials with significantly different physical or chemical properties, that when combined, produce a material with characteristics different from the individual components. The individual components remain separate and distinct within the finished structure. A composite material may be preferred for reasons that include materials which are stronger, lighter, or less expensive when compared to traditional materials of steel or aluminum. Still another advantage over metals is reduced corrosion, leading to longer operational life and reduced maintenance costs.

Composites typically have two constituent materials: matrix and reinforcement. The matrix material surrounds and supports the reinforcement materials by maintaining their relative positions. The reinforcements impart their special mechanical and physical properties to enhance the matrix properties. A synergism produces material properties unavailable from the individual constituent materials, while the wide variety of matrix and strengthening materials allows the designer of the product or structure to choose an optimum combination.

The use of fiber inclusions to strengthen a matrix is well known to the art. Well established mechanisms for the strengthening of a matrix include slowing and elongating the path of crack propagation through the matrix, as well as energy distribution associated with pulling a fiber free from the surrounding matrix material. In the context of sheet molding composition (SMC) formulations, bulk molding composition (BMC) formulations, and resin transfer molding (RTM) fiber strengthening has traditionally involved usage of chopped glass fibers, while carbon fibers are known to be high strength and low weight reinforcements.

Weight savings are particularly important for electric and hybrid vehicles powered with energy cells employing battery technologies in order to achieve greater vehicle driving range per charge. However, unique problems associated with some components of electric and hybrid vehicles have hindered the ability to use composite materials for some applications on hybrid or electric vehicles. For example, batteries of electric and hybrid vehicles present unique safety considerations owing to the high voltages of the batteries, chemicals employed in the battery technologies, combustion and fire risks associated with the batteries, and potential fume encounters if the batteries are broken or damaged. Therefore, batteries of electric and hybrid vehicles generally require protective containers designed to shield batteries from the elements and from forces they may otherwise experience during an impact or crash event.

Generally, such protective containers are high strength boxes formed of welded metals, which are heavy, prone to corrosion, and have been found to be water penetrable at at least the welds. Attempts have been made to form protective battery containers from composite materials to reduce the weight of such containers. However, such containers are usually joined with metal bolts, which require additional machining of through holes in the composite material of the container, placement of the bolts in the through holes, and securing of the bolts with nuts, leading to slow manufacturing throughputs and high manufacturing costs. Additionally, typical battery containment boxes formed of composite material are prone to degraded seals and failure given that the metal bolts and nuts used to join portions of the boxes together rub against and wear down the composite material near the bolt holes.

Thus, there exists a need for a battery containment construct that utilizes composite materials to lower the weight of the component, while increasing manufacturing throughput and improving the seal and performance of the battery containment construct as compared to conventional vehicle components.

### SUMMARY

The present invention provides a high strength, light weight battery containment construct for containing and protecting energy cells or batteries that provides impact resistance, fire resistance, and fluid penetration prevention. The battery containment construct includes a first housing portion, a second housing portion, and a joiner clip configured to hold the first housing portion and second housing portion together. The first housing portion has a first body and a first flange extending from the first body. According to embodiments, the first flange either partially or entirely surrounds the first body portion. The second housing portion has a second body and a second flange extending from the second body. According to embodiments, the second flange either partially or entirely surrounds the second body portion. The second flange of the second housing portion is configured to engage the first flange of the first housing portion such that the first body of the first housing portion and the second body of the second housing portion define a cavity therebetween, which may be configured to house at least one battery or energy cell. According to embodiments, the containment construct includes a barrier material, such as an adhesive, a gasket, or a connector, positioned between the first flange and the second flange. The joiner clip is configured with a C-shaped cross section to engage the first flange and the second flange to join the first housing portion to the second housing portion. According to embodiments, the housing portions are formed of a composite material such as reinforced sheet molding compound (SMC), a phenolic-SMC, epoxy, acrylonitrile butadiene styrene (ABS), polycarbonate, or random-oriented fiber reinforced thermoplastic resin (FRTP) and may be reinforced with carbon fibers, glass fibers, aramid fibers, cellulosic fibers, or a combination thereof.

### BRIEF DESCRIPTION OF THE DRAWINGS

The present invention is further detailed with respect to the following drawings that are intended to show certain aspects of the present invention but should not be construed as a limit on the practice of the present invention.

FIG. 1 is a cross sectional view of a portion of a battery containment construct according to embodiments of the present invention;

FIG. 2A is a bottom view of a first body portion of a battery containment construct according to embodiments of the present invention;

FIG. 2B is a top view of a second body portion of a battery containment construct according to embodiments of the present invention;

FIG. 3A is a bottom view of a first body portion of a battery containment construct according to embodiments of the present invention;

FIG. 3B is a top view of a second body portion of a battery containment construct according to embodiments of the present invention;

FIG. 4A is a top view of an assembled containment construct according to embodiments of the present invention;

FIG. 4B is a top view of an assembled containment construct according to embodiments of the present invention;

FIG. 4C is a top view of an assembled containment construct according to embodiments of the present invention;

FIGS. 5A-5D are side views of joiner clips according to embodiments of the present invention; and

FIG. 6 is a side view of a crimp clamp joiner clip according to embodiments of the present invention.

### DESCRIPTION OF THE INVENTION

The present invention has utility as a high strength, light weight containment construct for containing and protecting energy cells or batteries that provides impact resistance, fire resistance, and fluid penetration prevention. The present invention has utility as a sealable battery containment construct formed of composite materials that is more durable and less susceptible to wear and failure as compared to existing battery boxes.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below. As used in the description of the invention and the appended claims, the singular forms “a,” “an” and “the” are intended to include the plural forms as well, unless the context clearly indicates otherwise. Also as used herein, “and/or” refers to and encompasses any and all possible combinations of one or more of the associated listed items, as well as the lack of combinations when interpreted in the alternative (“or”).

As used herein “fluid penetration” refers to a single piece or joined piece construction that prevents unintended transit of gaseous or liquid coolants through a construct component in general.

Referring now to the figures, a battery containment construct 10 according to embodiments of the present invention includes a first housing portion 12, a second housing portion 14, and a joiner clip 16 having a C-shaped cross section that joins the two housing portions 12, 14 together. The housing portions 12, 14 and the joiner clip 16 are configured to be assembled in such a way as to form a high strength, light weight containment construct 10 that provides impact resistance, fire resistance, and fluid penetration prevention to contents contained within the construct 10, which according to embodiments is a plurality of batteries. The containment construct 10 is particularly suitable for containing batteries or energy cells of a hybrid or electric vehicle. The battery containment construct 10 protects the contents stored therein and at least partially absorbs and dissipates kinetic energy experienced during a crash or impact event.

Each housing portion has a body and a flange, that is, the first housing portion 12 has a first body 18 and a first flange 20 extending form the first body 18 and the second housing portion 14 has a second body 22 and a second flange 24 extending form the second body 22. The first flange 20 and the second flange 24 are configured to engage one another in abutting contact such that the first body 18 of the first housing portion 12 and the second body 22 of the second housing portion 14 define a cavity 26 therebetween. The cavity 26 is configured to receive and contain energy cells or batteries. The joiner clip 16 is configured to engage the first flange 20 and the second flange 24 to join the first housing portion 12 and the second housing portion 14 together.

According to embodiments, the housing portions 12, 14 of the containment construct 10 are formed of a composite material. According to certain inventive embodiments, the housing portions 12, 14 are formed of reinforced sheet molding compound (SMC), a phenolic-SMC, epoxy, acrylonitrile butadiene styrene (ABS), polycarbonate, or random-oriented fiber reinforced thermoplastic resin (FRTP). Sheet molding compound (SMC) or sheet molding composite is a ready to mold fiber-reinforced polyester material primarily used in compression molding. SMC is a reinforced composite material that is manufactured by dispersing long strands (20-60 mm) of chopped glass fibers in a matrix of polyester resin. It is appreciated that fibers with long range order are also operative herein and include woven mats, continuous fibers, or sheet forms. Thermoplastic materials operative herein amenable to functioning as a fiber matrix illustratively include: poly(methyl methacrylate) (PMMA), acrylonitrile butadiene styrene (ABS), polyamides, polylactides, polybenzimidazoles, polycarbonates, polyether sulfones, polyethylene, polypropylene, polystyrene, polyvinyl chloride, or block copolymers of any one of the aforementioned constituting the majority by monomer number. Reinforcing fibers and fillers operative herein illustratively include carbon fibers, glass fibers, aramid fibers, cellulosic fibers, or a combination thereof. In some inventive embodiments, the chopped fiber is glass fiber, alone or in combination with other types of fiber or reinforcing fillers. According to embodiments, the housing portions 12, 14 are formed of glass or carbon fiber reinforced SMC.

According to embodiments, a coating is readily applied to one or both of the housing portions 12, 14. The coating illustratively includes materials that impart fire resistance, are phenolic in nature, electromagnetic interference-radiofrequency interference (EMI-RFI) resistance, or a combination of such coatings. That is, according to embodiments, the housing portions 12, 14 are coated in a fire resistant, or a fire-retardant material. A fire-resistant material is one that is designed to resist burning and withstand heat and provide insulation to the substrate, while a fire-retardant material is designed to burn slowly and reduce the rate of flame spread. Intumescent fire-resistant materials work by expanding their volume from 15 to 30 times and generating an ash-like char layer that erodes as fire exposure continues. Expansion then occurs again with the number of times the process repeats itself dependent upon the thickness of the coating. For example, such fire resistant or fire retardant materials for coating the housing portions 12, 14 include any of the following: silicone, casein or vinyl resins, aluminum trihydrate or antimony oxide, ammonium polyphosphate, pentaerythritol, melamine derivatives, boric acid (H₃BO₃) and borax (Na₂B₄O₇.10H₂O), disodium octaborate tetrahydrate (Na₂B₈O₁₃.4H₂O), dicyandiamide-formaldehyde-phosphoric acid, melamine-dicyandiamide-formaldehyde-phosphoric acid, poly(n-vinylpyrolidone), colloidal silica, magnesium hydroxide (MDH), monoammonium phosphate (MAP), aluminum hydroxide (ATH), carbonates and hydrogen carbonates, potassium carbonate, Na₂WO₄, Na₂SnO₃, Na₂MoO₄, ammonium polyphosphate, pentaerythritol, melamine, expandable graphite, or combinations thereof. Phenolic resins operative herein illustratively includes epoxy phenolic resins, and phenol formaldehyde resins that impart corrosion resistance and a mar resistance surface relative to the underlying substrate of the construct 10. EMI-RFI shielding coatings operative herein illustratively include nickel coated glass mat; carbon fiber matting; copper or nickel paint; various metal foils, such as aluminum, nickel, iron, copper, and alloys thereof; and or combinations thereof with the proviso that the EMI-RFI shielding is grounded so as to function as a Faraday cage.

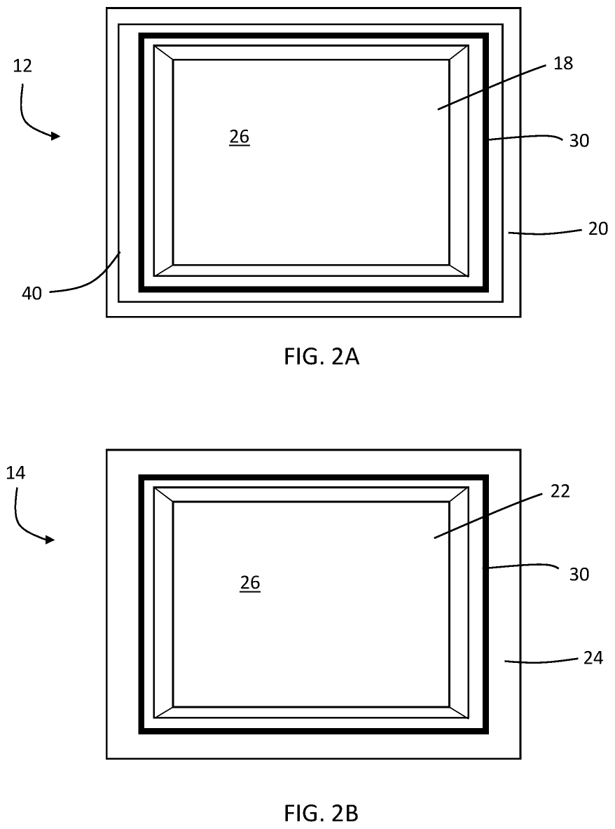

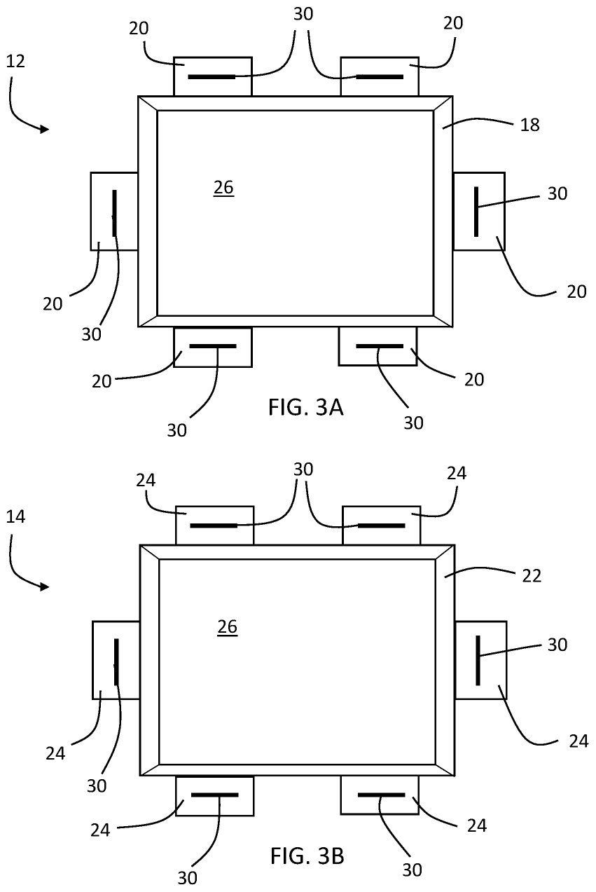

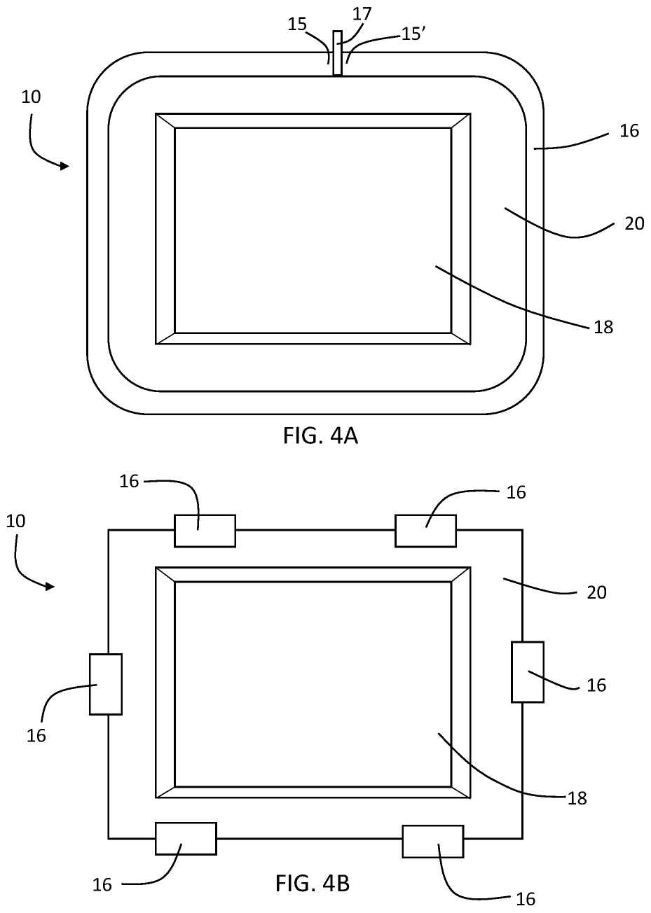

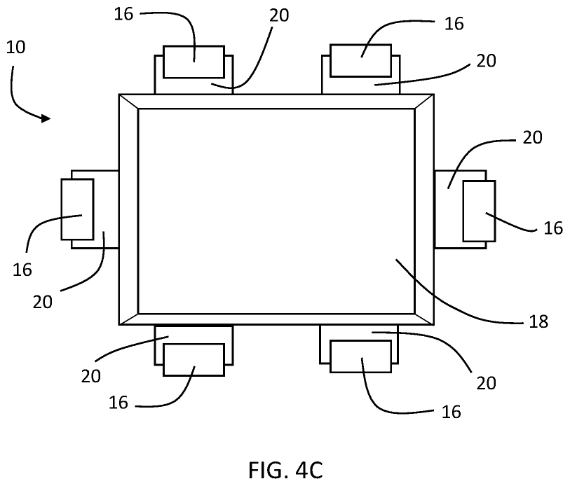

According to embodiments, the first flange 20 surrounds the perimeter of the first housing portion 12. Similarly, according to embodiments, the second flange 24 surrounds the perimeter of the second housing portion 14. According to embodiments, such as those shown in FIGS. 2A, 2B, 4A, and 4B, the flanges 20, 24 are each continuous in that they entirely cover the perimeter of the respective housing portions 12, 14. According to other embodiments, such as those shown in FIGS. 3A, 3B, and 4C, the flanges 20, 24 are each made up of separate and discrete flange portions that non-continuously surround the respective housing portions 12, 14. According to embodiments, in which the flanges 20, 24 are continuous and entirely surround the housing portions 12, 14, the joiner clip 16 is either a single continuous joiner clip, as shown in FIG. 4A, that also entirely surrounds the housing portions 12, 14, or the joiner clip 16 is a plurality of separate and discrete joiner clips, as shown in FIG. 4B, positioned at separate locations along the first flange 20 and the second flange 24 to non-continuously surround the housing portions 12, 14. According to embodiments, in which the flanges 20, 24 are each made up of separate and discrete flange portions that non-continuously surround the respective housing portions 12, 14, the joiner clip 16 is a plurality of separate and discrete joiner clips positioned at separate locations along the first flange 20 and the second flange 24 to non-continuously surround the housing portions 12, 14, as shown in FIG. 4C.

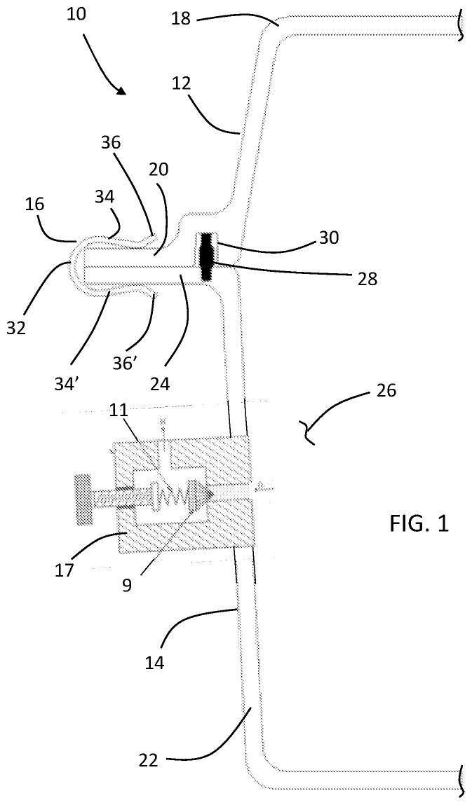

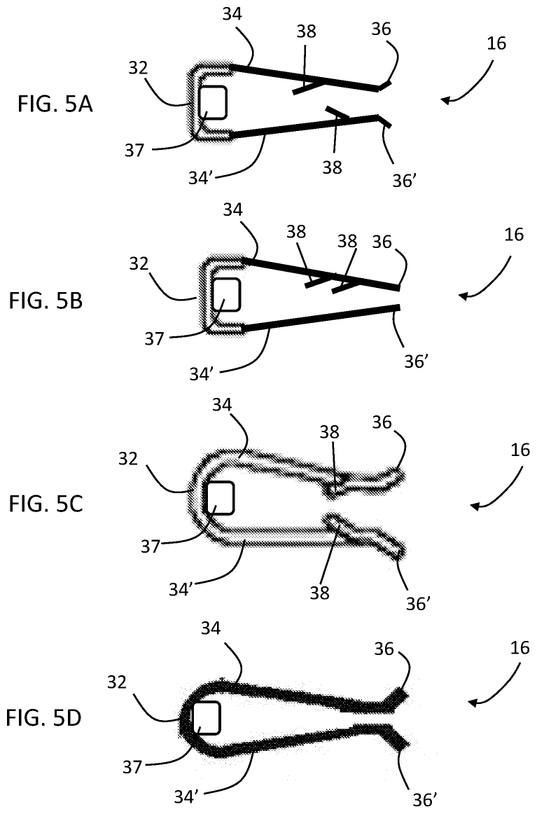

According to embodiments, such as those shown in FIGS. 1 and 5A-5D, the joiner clip 16 includes a base section 32 and a pair of jaws 34, 34′ extending from the base 32 section each jaw 34, 34′ of the pair of jaws having a free end 36, 36′, respectively. According to embodiments, the base section 32 is curved or square, as shown in FIGS. 5C-5D and 5A-5B, respectively. According to embodiments, one or both of the jaws 34, 34′ are straight or feature a curve such that the free ends 36, 36′ of each of the jaws 34, 34′ are flared away from one another, such as shown in FIGS. 5A and 5C-5D and 5B, respectively. The flared free ends 36, 36′ facilitate easy application of the joiner clip 16 onto the flanges 20, 24. That is, to apply the joiner clip 16, the flanges 20, 24 are positioned between the free ends 36, 36′ of the joiner clip and the joiner clip 16 is pushed or pounded onto the flanges 20, 24, thereby eliminating the need for a special tool for separating the jaws 34, 34′. The flared free ends 36, 36′ also reduce wear on the composite material of the flanges 20, 24 by ensuring that the free ends 36, 36′ do not rub on the flanges 20, 24.

According to embodiments, the free ends 36, 36′ of each of the jaws 34, 34′ are biased toward one another. Thus, when the joiner clip 16 is engaged with the flanges 20, 24, such that the flanges 20, 24 are positioned between the jaws 34, 34′ of the joiner clip 16, the joiner clip applies a compressive force to the first flange 20 and the second flange 24 to join the first housing portion 12 and second housing portion 14 together. According to embodiments, the joiner clip is formed of a metal, such as spring steel, a thermoplastic, or an elastomeric material. Embodiments in which the joiner clip is formed of an elastomeric material provide the additional benefit of sealing the portions of the housing 12, 14 while also joining them together. According to embodiments, the joiner clip 16 also includes at least on barb positioned on an inner surface of at least one of the jaws 34, 34′. The barb or barbs 38 are configured to dig into the composite material of the flanges 20, 24 or may engage with a groove 40 formed in the flanges to prevent the joiner clip 16 from falling off of or being easily removed from the flanges 20, 24.

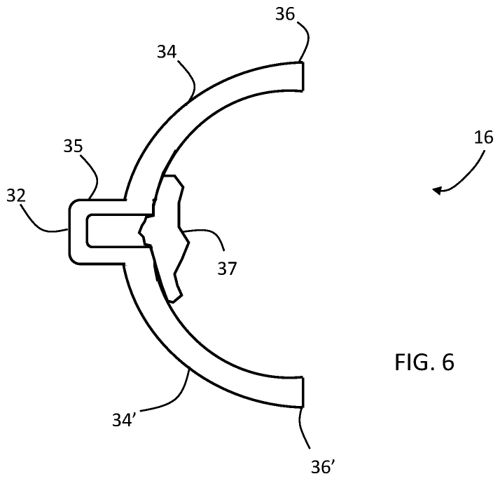

According to embodiments, the joiner clip 16 is a crimp clamp, such as that shown in FIG. 6. The crimp clamp joiner clip 16 includes a base section 32 and a pair of jaws 34, 34′ extending from the base 32 section of each jaw 34, 34′ of the pair of jaws having a free end 36, 36′, respectively. According to embodiments, the base section 32 includes an ear section 35, as shown in FIG. 6. According to embodiments, the jaws 34, 34′ curve out from the ear section 35 such that the crimp clamp joiner clip 16 forms a semi-circle with the free ends 36, 36′ of each of the jaws 34, 34′ spaced apart from one another. According to embodiments, the crimp clamp joiner clip 16 is formed for a metal, thermoplastic, or elastomeric material that is deformable yet resilient even after deformation. To apply the crimp clamp joiner clip 16, the flanges 20, 24 are positioned between the free ends 36, 36′ of the non-deformed crimp clamp joiner clip, that is in its semi-circular configuration. Next, the free ends 36, 36′ of the crimp clamp joiner clip 16 are pinched or crimped into contact with the flanges 20, 24. According to embodiments, the free ends 36, 36′ of the crimp clamp joiner clip 16 are pinched or crimped using an automated system that for example includes rollers that apply a compressive force to the free ends 36, 36′ of the crimp clamp joiner clip 16. Thus, when the crimp clamp joiner clip 16 is deformed into clamped engagement with the flanges 20, 24, such that the flanges 20, 24 are positioned between the deformed jaws 34, 34′ of the joiner clip 16, the joiner clip applies a compressive force to the first flange 20 and the second flange 24 to join the first housing portion 12 and second housing portion 14 together. It will be understood that use of such a joiner clip allows the length of the flanges 20, 24, that is the distance the flanges 20, 24 extend from the body portions 18, 22, to be shortened. Accordingly, the overall weight and size of the containment construct 10 is reduced, particularly compared to a containment construct that uses fasteners such as bolts to join the portions of the housing.

According to embodiments, the joiner clip 16 includes a gasket material 37 positioned near the base 32 of the joiner clip 16. The gasket material 37 is compressed into a sealed configuration upon contact with the first flange 20 and second flange 24 and acts to seal the portions of the housing 12, 14 in watertight and airtight engagement. According to embodiments, the gasket material 37 is attached to the joiner clip 16, while in other embodiments, the gasket material 37 is a separate piece of material that is simply placed within the joiner clip 16 prior to installation on the flanges 20, 24.

According to embodiments, the containment construct 10 also includes a barrier material 28 positioned between the first flange 20 and the second flange 24. According to embodiments, the barrier material 28 acts as a seal and/or a connector between the first housing portion 12 and the second housing portion 14 to limit movement or slippage between the first housing portion 12 and the second housing portion 14. According to embodiments, the barrier material 28 is any of an adhesive, a gasket, silicone, or a connector. In some embodiments, such as that shown in FIG. 1, at least one of the first flange 20 and second flange 24 define a channel 30 that is configured to receive and retain the barrier material 28. The channel 30 may be a continuous channel or may be a plurality of discrete channels spaced along the length of at least one of the flanges 20, 24 at spaced apart positions. According to embodiments, the channel 30 is formed in at least one of the flanges 20, 24 when the housing portion 12, 14 is formed or molded, or may be subsequently cut, drilled, or stamped into the at least one flange 20, 24. According to embodiments in which at least one of the flanges 20, 24 includes a channel, the barrier material 28 is placed in the channel 30 before the flanges 20, 24 are brought into contact with one another. According to embodiments, in which both flanges 20, 24 define a channel 30 therein, the barrier material 28 is placed in the channel 30 of for example the first flange 20 and then the second flange 24 is brought into contact with the first flange 20 and the barrier material. In such embodiments, the barrier material 28 can be used as a position locator for ensuring that the first flange 20 and second flange 24 are properly positioned relative to one another. Additionally, once assembled, the barrier material 28 ensures that the first housing portion 12 and the second housing portion 14 remain properly positioned relative to one another during use, by preventing slippage, which in turn reduces wear on the parts. It will also be understood that when the barrier material 28 is a gasket, the barrier material may act to seal the portions of the housing 12, 14 in watertight engagement and act to locate and retains the position of the housing portions 12, 14 relative to one another.

According to embodiments, the containment construct 10 additionally includes a pressure relief valve 17, which acts to vent pressure that may build up within the cavity 26, for example due to fire within the cavity 26 or some other failure of the contents contained within the containment construct 10 that result in a pressure build up. According to embodiments, the pressure relief valve 17 is positioned through at least one of the housing portions 12, 14, such as shown in FIG. 1. According to embodiments, the pressure relief valve 17 is threaded or otherwise secured within a hole that is formed in the at least one housing portion 12, 14. Such a hole for the pressure relief valve 17 may be formed in at least one of the housing portions 12, 14 when it is formed or molded, or may be subsequently cut, drilled, or stamped into the at least one of the housing portions 12, 14. According to embodiments, the pressure relief valve 17 is positioned between the flanges 20, 24 between the ends 15, 15′ of the joiner clip 16, such as shown in FIG. 4A. According to embodiments, the pressure relief valve 17 includes a valve element 9 that is held in a closed position by a spring 11 until the pressure build up within the cavity 26 overcomes the force of the spring 11 at which point the pressure forces the valve element 9 open so the pressure build up may escape.

According to certain inventive embodiments, at least one of the housing portions 12, 14 includes internal divider walls internally, which divide the cavity 26 into sections of sub-cavities. The internal divider walls provide additional structural rigidity to the battery containment construct 10 and provide support to batteries positioned within the containment construct 10 to limit shifting of the batteries within the containment construct. According to embodiments, at least one of the housing portions 12, 14 includes a through hole defined in at a wall of the body. The through hole allows a wire or cable to be passed therethrough, such as a high voltage wire for connecting the batteries contained within the battery containment construct 10 to the other systems of the hybrid or electric vehicle systems.

According to certain inventive embodiments, a containment construct 10 has dimensions suitable to contain batteries of an electric or hybrid vehicle. For example, embodiments of the inventive battery containment construct are a height of 100 to 500 mm, a length of 100 to 5000 mm, and a width of 100 to 3000 mm. According to embodiments, multiple layers of batteries are stacked within the containment construct 10, resulting in taller containment constructs. According to embodiments, multiple layers of containment constructs 10 are stacked.

The present invention is further detailed with respect to the following non-limiting examples. These examples are exemplary of specific embodiments of the present invention and not intended to limit the scope of the appended claims.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A battery containment construct comprising:
a first housing portion having a first body and a first flange extending from the first body;
a second housing portion having a second body and a second flange extending from the second body, the second flange being configured to engage the first flange such that the first body of the first housing portion and the second body of the second housing portion define a cavity therebetween; and
a joiner clip configured with a C-shaped cross section to engage the first flange and the second flange to join the first housing portion to the second housing portion.

2. The battery containment construct of claim 1 further comprising a barrier material configured to be positioned between the first flange and the second flange.

3. The battery containment construct of claim 2 wherein at least one of the first flange and the second flange define a channel therein configured to receive the barrier material.

4. The battery containment construct of claim 2 wherein the barrier material is any of an adhesive, a gasket, or a connector.

5. The battery containment construct of claim 1 wherein the first housing portion and the second housing portion are formed of a composite material.

6. The battery containment construct of claim 5 wherein the composite material is any of reinforced sheet molding compound (SMC), a phenolic-SMC, epoxy, acrylonitrile butadiene styrene (ABS), polycarbonate, or random-oriented fiber reinforced thermoplastic resin (FRTP).

7. The battery containment construct of claim 5 wherein the composite material is reinforced with carbon fibers, glass fibers, aramid fibers, cellulosic fibers, or a combination thereof.

8. The battery containment construct of claim 1 wherein the first flange surrounds the first housing portion.

9. The battery containment construct of claim 1 wherein the second flange surrounds the second housing portion.

10. The battery containment construct of claim 1 wherein the cavity is configured to house a battery.

11. The battery containment construct of claim 1 wherein the joiner clip comprises a base section and a pair of jaws extending from the base section each jaw of the pair of jaws having a free end.

12. The battery containment construct of claim 11 wherein the free ends of each of the jaws of the pair of jaws are biased toward one another.

13. The battery containment construct of claim 11 wherein the free ends of each of the jaws of the pair of jaws are flared away from one another.

14. The battery containment construct of claim 11 wherein at least one of the jaws of the pair of jaw has a barb on an inner surface thereof.

15. The battery containment construct of claim 1 wherein the joiner clip is formed of one of a metal, a thermoplastic, or an elastomeric material.

16. The battery containment construct of claim 15 wherein the metal is spring steel.

17. The battery containment construct of claim 1 wherein the joiner clip is a plurality of discrete joiner clips positioned at separate locations along the first flange and the second flange.

18. The battery containment construct of claim 1 wherein the joiner clip is a continuous joiner clip that extends around the entire first housing portion and second housing portion.

19. The battery containment construct of claim 1 wherein the joiner clip is configured to apply a compressive force to the first flange and the second flange.

20. The battery containment construct of claim 1 wherein the joiner clip is a crimp clamp.
